(19) United States
(12) Patent Application Publication
(10) Pub. No.: US 2014/0265238 A1
(43) Pub. Date: Sep. 18, 2014

(54) Fender for a wheeled chair

(71) Applicant: David B. Storm, Cookeville, TN (US)

(72) Inventor: David B. Storm, Cookeville, TN (US)

(21) Appl. No.: 14/212,413

(22) Filed: Mar. 14, 2014

Related U.S. Application Data
(60) Provisional application No. 61/788,079, filed on Mar. 15, 2013.
(60) Provisional application No. 61/822,958, filed on May 14, 2013.

(51) Int. Cl. A61G 5/10

(52) U.S. Cl. CPC A61G 5/10
USPC 280/304.1

(57) ABSTRACT

Apparatus for covering the tire of a wheelchair to prevent contact with the tire by the chair's occupant. A pair of fenders cover the upper portion of the large tires on a wheel chair. Each fender includes a body, a front attachment, and a rear attachment. The body is configured to cover the top and a portion of the front of the large tire. The front attachment connects the front of the body to a member on the wheelchair, such as the frame or the handbrake associated with the tire. The rear attachment connects the rear of the body to another member on the wheelchair. The front and rear attachments support the body a slight distance above the large tire. In one embodiment the fender is movable radially relative to the wheel such that the chair's occupant, by pressing down on the fender, is able to brake the wheel.

### CROSS-REFERENCE TO RELATED APPLICATIONS

This application claims the benefit of U.S. Provisional Application No. 61/788,079, filed Mar. 15, 2013, and of U.S. Provisional Application No. 61/822,958, filed May 14, 2013.

### STATEMENT REGARDING FEDERALLY SPONSORED RESEARCH OR DEVELOPMENT

Not Applicable

### BACKGROUND

1. Field of Invention

This invention pertains to a fender for a wheelchair. More particularly, this invention pertains to a floating fender that covers a portion of the large tire on the wheelchair, thereby protecting the hands of the chair occupant from contamination.

2. Description of the Related Art

Wheelchairs are common vehicles in health care facilities such as hospitals, assisted living facilities, and nursing homes. For many people wheelchairs allow them to be mobile and move about more than they could without such chairs. But in order to move about the wheelchair occupant typically uses their hands to rotate the wheel. Because the wheels are in direct contact with the floor, whatever is on the floor often ends up on the occupant's hands.

Unfortunately, areas where wheelchairs are commonly used often are areas with pathogens. For example, healthcare facilities are filled with sick people and these people often sneeze, cough, or otherwise spread germs on the floor. Wheelchairs are also used to transport patients to wash areas and bathroom facilities, which often have fecal matter on the floor. Clostridium difficile (C. Difficile or C. Diff) is a deadly bacteria.

Transmission of C. difficile from one person to another often follows the vector from fecal matter to oral ingestion, such as can occur when fecal matter contaminates an object, such as the wheels on a wheelchair, that is then touched by someone, such as the wheelchair occupant. That person then handles food and/or medicine, which causes the contamination to be ingested, thereby infecting the person. The infected person may experience overgrowth of C. difficile. The overgrowth is harmful because the bacterium releases toxins that potentially causes bloating, constipation, and diarrhea with abdominal pain, which may become severe. In elderly persons or those with frail immune systems, overgrowth of C. difficile often has severe, and sometimes deadly, consequences. Clostridium difficile is the most serious cause of antibiotic-associated diarrhea (AAD) and can lead to pseudomembranous colitis, a severe infection of the colon. The C. difficile bacteria naturally reside in the body at non-toxic levels, normally.

Wheelchairs have a handrim next to the large tires. The handrim is spaced away from the large tire and intended to be grasped by the chair occupant to drive the chair forward. Many occupants prefer to use the tires to propel the wheelchair because the rubber tires are larger and are easier to grasp than the smaller handrims, which are typically chromed and smooth.

Accordingly, it is an objective of the invention to prevent the occupant of a wheelchair from contacting the portion of the tires of the wheelchair that come into contact with the floor.

It is another objective of the invention to protect the occupant of a wheelchair from becoming contaminated by any pathogens on the floor in the path of his wheelchair.

### BRIEF SUMMARY

According to one embodiment of the present invention, fenders for a wheeled chair are provided. The wheeled chair is a wheelchair, a transport chair, or other wheeled chair used to transport persons. Generally, such chairs have a rubber-type tire with a handrim used by the chair occupant to propel the chair. The fenders cover the upper portion of each tire where the chair's occupant is likely to contact the tire. In this way, the chair's occupant is protected from contacting the tires and the occupant's hands are protected from being contaminated with any bacteria and viruses that are on the floor and transferred to the tire.

The fenders are dimensioned to fit over a portion of each of the large tires of the chair. Each fender includes a body, a front attachment, and a rear attachment. The front of each fender covers a portion of the front of the large tire and includes the front attachment. The front attachment connects the fender to a member, such as the brake lever, on the chair. In one embodiment the front attachment is a clamp configured to attach to the brake lever. The rear portion of each fender covers the top of the large tire and extends rearward past the back support of the chair. The rear portion of each fender includes the rear attachment. The rear attachment secures the fender over the tire such that the wheel is able to rotate freely with the fender held in position. In one embodiment the rear portion of each fender is loosely secured over the tire such that the fender can be pressed down onto the tire to act as a brake to slow or stop the wheel from rotating.

In one embodiment, the rear attachment is a clip inside the fender. The clip has resilient ends that fit over the tire and secure the rear portion of the fender over the tire. In another embodiment, the rear attachment is a pair of opposed thumbscrews in the fender body sidewalls that engage the rim of the tire to prevent the rear of the fender from being lifted up from the tire. In yet another embodiment, the rear attachment includes a suspender and a securing member. In one such embodiment the suspender is a roller inside the fender and the securing member is an elastic cord that attaches to the fender and loops around the axle of the chair. In this way the fender floats over the tire with minimal risk of being lifted from the tire. In another such embodiment the suspender is a strut attached to the rear of the fender and the securing member is the distal end that engages the axle portion of the tire.

### BRIEF DESCRIPTION OF THE SEVERAL VIEWS OF THE DRAWINGS

The above-mentioned features will become more clearly understood from the following detailed description read together with the drawings in which:

FIG. 1 is a perspective view of a foot sling attached to a wheeled chair.

FIG. 2 is a side view of the outside of one embodiment of a fender.

FIG. 3 is a side view of one embodiment of a fender front clamp.

FIG. 4 is a cross-sectional view of one embodiment of the rear attachment mechanism of the fender.

FIG. 5 is a cross-sectional view of another embodiment of the rear attachment mechanism of the fender.

FIG. 6 is a side view of the seat side of another embodiment of a fender.

FIG. 7 is a cross-sectional view of the fender illustrated in FIG. 6.

FIG. 8 is a side view of the seat side of yet another embodiment of a fender.

FIG. 9 is a partial side view of another embodiment of an end of the strut.

### DETAILED DESCRIPTION

An apparatus for wheeled chairs is disclosed. A fender 100 protects the hands of the chair occupant from contacting pathogens and contaminates transferred from the floor to the tire of the chair. The fender is generally indicated as 100 with particular embodiments shown in the figures and described below having an alphabetic suffix, for example, 100-A, 100-B.

FIG. 1 illustrates a perspective view of a fender 100 attached to a wheeled chair 102. The wheeled chair 102 is a wheelchair, a transport chair, or other wheeled chair used to provide mobility for persons. Generally, such chairs 102 have a pair of large tires, or wheels, 128 with a handrim 142 that the occupant uses to propel the chair 102.

The fender 100 floats over a portion of the tire 128 of the chair 102. Generally, a chair's occupant will grasp the handrim 142 near the top of the wheel 128 and roll the wheel 128 forward until releasing the handrim 142 when the occupant's hand is near the front of the wheel 128. The fender 100 is dimensioned to cover the upper portion of each tire 128 where the hands of the chair's occupant are likely to contact the tire 128. In this way, the chair's occupant is protected from contacting the tires 128 and the occupant's hands are protected from being contaminated with any bacteria and viruses that are on the floor and transferred to the tires 128. The front of the fender 100 extends and covers a portion of the front of the tire 128. The fender 100 has a front attachment 134 that connects the fender 100 to a member of the chair 102. The fender 100 covers the top of the tire 128 and the rear of the fender 100 extends back to at least where the backrest of the seat 122 meets the tire 128.

In the illustrated embodiment, the front of each floating fender 100 attaches to the brake lever 126 of the hand brake 124. The rear portion of the floating fender 100 is restained over the tire 128. In this way, when the chair's occupant grasps the handrim 142, the occupant will not come into contact with the portion of the wheel 128 that also contacts the floor.

FIG. 2 illustrates a side view of one embodiment of a fender 100-A. The fender 100-A floats over the tire 128 of the wheeled chair 102. Wheelchairs 102, such as the one shown in FIG. 1, have large diameter rear wheels 128, each with an associated handrim 142. The occupant grasps the handrims 142 to manually propel the chair 102. Oftentimes the occupant grasps or touches the tire 128 to propel the chair 102. Grasping the tire 128 is risky because the tire 128 moves on the floor. Contaminates and pathogens from the floor are easily transferred to the occupant's hands by the occupant touching the tires 128.

The fender 100-A includes a body 202 having a front attachment 134 and a rear attachment 220. The body 202 of the fender 100 has a pair of sidewalls that extend toward the axle of the large tire 128 and cover a portion of the sidewall of the tire 128. The front attachment 134-A secures the front portion of the body 202 to a member on the wheelchair 102, such as the hand brake 124. The rear attachment 220 secures the rear portion of the body 202 to another member of the wheelchair 102, such as a part of the axle of the wheel 128, the rim of the wheel 128 that supports the rubber tire, or even the sidewalls of the tire 128.

To prevent the occupant from contacting the tire 128, the body 202 of the fender 100-A is positioned over and around the portion of the tire 128 that the occupant is most likely to grasp to move the chair 102. The fender 100-A floats over the top of the tire 128. The front of each floating fender 100-A includes a clamp 210 with an opening 204 that receives the brake lever 126 of the hand brake 124. The rear of the floating fender 100-A extends behind the back rest of the chair 102 and is restained over the tire 128.

In another embodiment, the inside sidewall of the fender 100 is attached directly to the side of the wheelchair 102. For example, the chair 102 has vertical uprights supporting the arm rests. Between the vertical uprights is a panel or plate that isolates the occupant from the wheel. The fender 100 is attached to either the vertical uprights or the panel with fasteners.

FIG. 3 illustrates a side view of one embodiment of the front attachment 134-A, which is a front fender clamp 210. The clamp 210 includes a lip 302 that attaches to the body 202 of the fender 100 with a fastener 208, such as a rivet, a screw, or a bolt. Extending beyond the end of the fender body 202 is the clamp portion 304. The clamp portion 304 is configured to attach to the side of the brake lever, or blade, 126 opposite the side that contacts the tire 128 when braking the chair 102.

The clamp portion 304 includes a slot 204 and a setscrew 306. Most wheelchairs 102 have a brake lever 126 that is a flat section of metal with one edge that presses against the large tire 128. The slot 204, in one embodiment, is sized to fit over the blade of the brake lever 126. With the brake lever 126 of the brake in the slot 204, the setscrew 306 is screwed into the clamp portion 304 to clamp the brake lever 126 within the slot 204. Chairs 102 have various configurations of brake levers 126, for example, some brake levers 126 are round members with a knurled surface, some brake levers 126 have a wing shape. Another embodiment of the clamp portion 304 includes a slot 204 configured to receive the various configurations of brake levers 126. For example, the slot 204 is adjustable with one of the jaws 310 being movable or having a jaw face that moves relative to a jaw support that is stationary relative to the clamp portion 304. In yet another embodiment the front attachment 134 connects to a frame member of the chair 102 that is proximate the front of the wheel 128.

FIG. 4 illustrates a cross-sectional view of one embodiment of the rear attachment or restraint 220-A of the fender 100-A. To aid in understanding the figure, the portion of the fender body 202 extending past the clip 404 is not shown in the figure. The fender body 202 has a sidewall 402 on the side of the body 202 that is distal to the chair 102. The sidewall 402 extends toward the axle of the tire 128 adjacent to the handrim 142 to minimize the risk of the occupant catching their fingers between the fender 100 and the handrim 142. The distance the sidewall 402 extends toward the axle is limited by the manner the handrim 142 is attached to the wheel 128.

The rear of the fender body 202 is supported over the tire 128 with a clip 404 attached to the inside of the body 202. The clip 404 is a resilient material, such as plastic or spring steel, that has a throat 406 that is narrower than the tire 128 is wide. In this way the tabs 408 defining the throat 406 move apart when the rear of the fender 100-A is moved in place over the tire 128. With the fender 100-A installed, the outer portion of the tire 128 is slideably contained inside the clip 404 and the tabs 408 restrain the fender 100-A from being readily being pulled upward and removed. The clip 404 is secured to the body 202 by a fastener 206. To avoid scoring or otherwise damaging the tire 128, the fastener 206 is a rivet with an inside portion that is rounded or otherwise does not present a sharp-edged profile. In another embodiment, the fastener 206 is a screw or bolt with a rounded cap protruding inside the clip 404.

FIG. 5 illustrates a cross-sectional view of another embodiment of the rear attachment or restraint 220-B of the fender 100-B. To aid in understanding the figure, the portion of the fender body 202 extending past the fasteners 502 is not shown in the figure.

The fender 100-B includes a pair of fasteners 502, such as thumbscrews, that have a threaded portion 504 extending into the space between the sidewalls of the fender body 202. The tips 506 of the retaining fasteners 502 define a throat 406 that is narrower than the tire 128 is wide. In one embodiment the fasteners 502 are nylon or other smooth plastic that has a tip 506 that will glide or slide over the rim of the tire 128. In one such embodiment a felt flap hangs over the tip 506. In another embodiment the tips 506 have a cap or end that has a smooth or sliding surface, such as felt or ultra-high-molecular-weight polyethylene (UHMW) or Teflon material.

To install the fender 100-B, the thumbscrews 502 are withdrawn sufficiently to allow the tire 128 to pass through the throat 406. With the fender 100-B in place over the tire 128 the thumbscrews are tightened such that the throat 406 is narrower than the widest part of the tire 128 within the area defined by the inside of the body 202 and the fasteners 502. In this way the fender 100-B is captive with respect to the tire 128. The inside surface of the body 202 provides a smooth surface for the tire 128 to rotate within the body 202, thereby avoiding abrasion of the tire 128 and the body 202 of the fender 100-B.

FIG. 6 illustrates a side view of the seat side of another embodiment of a fender 100-C. The body 202-L′ of the illustrated fender 100-C fits on the left side of the chair 102. The corresponding body that fits on the right side of the chair 102 is a mirror image of the illustrated body 202-L′. The body 202-L′ has a front end 622 and a rear end 604, corresponding to the front and rear of the chair 102.

The front portion 622 of the body 202-L′ has a front attachment 134-B that includes a tab 602 and a clamp 210. The tab 602 extends from the forward end of the body 202′-L. The tab 602 is attached to the front fender clamp 210 with at least one fastener 208. In the illustrated embodiment, the fastener 208 engages a threaded hole in the lip 302 of the clamp 210, thereby securing the clamp 210 to the body 202-L′.

The rear portion 604 of the body 202-L′ includes rear attachment 220-C that includes a suspender that is a roller 702 (illustrated in FIG. 7) and securing member that is an elastic cord 612. The elastic cord 612 has one end 614 captured by a hole 608 in a sidewall 620 of the body 202-L′. The cord end 614 in various embodiments is knotted, crimped, or otherwise unable to fit through the hole 608, thereby anchoring the end 614 to the body 202-L′. The other end 616 of the elastic cord 612 has a loop with a metal crimp 618. The cord 612 fits into the slot 610 where the crimped end 616 is held captive. With the elastic cord 612 looped around the axle of the chair 102 and the two ends 614, 616 of the cord 612 secured in the body 202-L′, the rear portion of the fender 100-C is secured to the wheel 128.

In the illustrated embodiment the cord ends 614, 616 protrude from the sidewall 620 outside the body 202-L′ with the cord 612 extending inside and downward from the body 202-L′. In this way the cord ends 614, 616 will not contact the tire 128 and be subject to rubbing induced wear. The tension in the cord 612 stretches the cord 612 taut and prevents the cord 612 from contacting the wheel 128.

FIG. 7 illustrates a cross-sectional view of the rear portion 604 of the fender 100-C illustrated in FIG. 6. In the illustrated embodiment the rear attachment 220-C has a fastener 704 with a round head 706 extending between the two sidewalls 620, 710 of the body 202-L′. The round head 706 protrudes from the sidewall adjacent the handrim 142 so that the head 706 will not present a hazard to the occupant. A nut 606 engages the fastener 704 to secure the fastener 704 to the body 202-L′. The nut 706 is on the sidewall 620 adjacent the seat 122 of the chair 102 and is protected from contact with the occupant by the armrests and the panel under the armrests. Because the sidewalls 620, 710 are curved where the fastener 704 passes through the sidewalls 620, 710, resilient washers 708 provide a transition between the sidewalls 620, 710 and the head 706 and nut 606.

The fastener 704 is an axle for a roller 702 that rotates relative to the fastener 704. With the elastic cord 612 looped around the corresponding axle of the chair's large wheel 128, the roller 702 is biased against the wheel 128. The outer surface of the roller 702 engages the outer surface of the tire 128, thereby allowing the fender body 202-L′ to ride above the tire 128 with the roller 702 being a bearing between the body 202-L′ and the wheel 128.

To install the fender 100-C, the front attachment 210 at the front portion 622 is attached to the brake lever 126. The elastic cord 612 of the rear attachment 220-C is then looped under the axle portion of the tire 128 that is between the tire 128 and the chair seat 122. The free end 616 of the cord 612 is fed through the slot 610 until it is seated at the end of the slot 610. The tension in the cord 612 pulls the end 616 against the sidewall 620, thereby locking the free end 616 in the slot. With the cord 612 positioned beside the wheel 128, the roller 702 inside the body 202-L′ is biased against the wheel 128, providing a friction-free interface with the wheel 128 when it rotates.

FIG. 8 illustrates a side view of the seat side of yet another embodiment of a fender 100-D. The fender 100-D has a body 202 with a front attachment 210 and a rear attachment 220-D. The rear attachment 210-D includes a suspender that is a strut 802-A and a securing member that is an elastic loop 808. The strut 802-A is attached to the body 202 with a fastener 804, such as a rivet. The opposite end of the strut 802-A has a bearing surface 812 that is radiused to fit against an axle portion of the tire 128. The elastic loop 808 has one end attached to the strut 802-A and an opposite end with a small loop 810 that engages a notch 806 in the strut 802-A. The elastic loop 808 encircles the bottom of the axle portion of the tire 128 and holds the end of the strut 802-A against the axle portion.

FIG. 9 illustrates a partial side view of another embodiment of an end of the strut 802-B of the rear attachment 220-E. The illustrated strut 802-B has a connection to the body 202 that is the same as illustrated in FIG. 8. The opposite end of the strut 802-B includes a bearing surface 812 that is radiused to fit against an axle portion of the tire 128. The bearing surface 812 extends downward into a pair of opposing nubs 902 that hold the axle portion captive in the end of the strut 802-B.

The fender 100 includes various functions. The function of securing the rear portion 604 of the fender 100 is implemented by the rear attachment 220-A, which, in one embodiment, includes a clip 404 such as illustrated in FIG. 4. In another embodiment, the rear attachment 220-B includes a pair of fasteners 502 as illustrated in FIG. 5. In yet other embodiments the rear attachment 220-C, 220-D, 220-E includes a suspender 702, 802 and a securing member 612, 808, 902. In one such embodiment the rear attachment 220-C securing member is an elastic cord 612 and the suspender is a roller 702, such as illustrated in FIGS. 6 and 7. In still yet other embodiments the rear attachment 220-D, 220-E includes a suspender that is a strut 802-A, 802-B that has one end attached to the body 202 and the other end held against an axle portion of the tire 128 by the securing member that is a elastic loop 808 or a pair of opposing nubs 902.

The function of biasing the fender body 202 against the tire 128 of the chair 102 is implemented, in one embodiment, by the elastic cord 612, which is configured to be looped around the axle of the tire 128. The elastic cord 612 has a length that requires the cord to be stretched to loop around the tire's axle and have both ends 614, 616 secured to the sidewall 620 of the body 202-L′. The stretched cord 612 biases the rear portion 604 of the body 202-L′ against the tire 128. In another embodiment the strut 802-A has a distal end with an elastic loop 808 that engages an axle portion of the wheel 128.

The function of securing the front of the fender body 202, 202-L′ to the chair 102 is implemented, in one embodiment, by the front attachment 134, which is a clamp 210 attached to the body 202, 202-L′. The clamp 210 is configured to attach to a member 126 of the chair's brake 124 without inhibiting or interfering with the operation of the brake 124.

From the foregoing description, it will be recognized by those skilled in the art that a fender 100 for a wheelchair 102 has been provided. The fender 100 provides protection for the occupant of the chair 102 against contaminates and pathogens that accumulate on the tire 128 from being transferred to the occupant. The fender 100 is readily added and removed to a chair 102 with minimal effort, thereby aiding in keeping the chair 102 and fender 100 clean and hygienic.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. An apparatus for covering a portion of a large tire on a chair, the chair being a wheelchair with a pair of large tires with a seat therebetween, said wheelchair having a pair of hand brakes that engage a corresponding one of said pair of large tires in order to prevent said corresponding one of said pair of large tires from rotating, said apparatus comprising:
a body configured to fit over a portion of the large tire on the wheelchair, said body having a front portion and a rear portion, said body having a first sidewall sized to extend toward an axle of said large tire and cover a portion of a sidewall of said large tire, said body having a second sidewall sized to extend toward the axle of said large tire and cover a portion of an opposite sidewall of said large tire;
a front attachment at said front portion of said body, said front attachment configured to attach to a first member on said wheelchair; and
a rear attachment at said rear portion of said body, said rear attachment configured to attach to a second member on said wheelchair,
said front and rear attachments configured to support said body away from said large tire such that there is a specified gap between said large tire and an inside surface of said body.

2. The apparatus of claim 1 wherein said front attachment is a clamp configured to attach to a hand brake of the wheelchair.

3. The apparatus of claim 2 wherein said clamp attaches to a blade of said hand brake.

4. The apparatus of claim 1 wherein said front attachment includes a roller positioned between a pair of sidewalls of said body such that said roller engages the large tire when said body is attached to the wheelchair.

5. The apparatus of claim 1 wherein said rear attachment includes an elastic strap configured to engage an axle portion of said large tire.

6. The apparatus of claim 1 wherein said rear attachment includes a suspender and a securing member, said suspender configured to space said rear portion of said body away from said large tire, and said securing member configured to restrain said rear portion of said body from moving away from said large tire.

7. The apparatus of claim 1 wherein said rear attachment includes a member that engages a rim supporting said large tire on the wheelchair.

8. The apparatus of claim 1 wherein said rear attachment is flexible such that a force applied to said body in a direction toward the axle of said large tire causes said body to engage a surface of said large tire whereby said body acts as a manual brake for the wheelchair.

9. An apparatus for covering a portion of a wheel on a chair, said apparatus comprising:
a body defining a fender for a large tire on the chair, said body having a front portion and a rear portion;
a clamp attached to said forward portion of said body, said clamp configured to attach to a blade of a hand brake of the wheelchair, said clamp configured to support said forward portion above the large tire of the wheelchair; and
a restraint attached to said rear portion of said body, said restraint configured to restrain said rear portion relative to said large tire of the chair.

10. The apparatus of claim 9 wherein said clamp defines a slot dimensioned to receive the blade of the hand brake, and said clamp including a member configured to secure the blade in said slot.

11. The apparatus of claim 9 said restraint defines a throat that is narrower than the large tire is wide, said restraint configured to support said rear portion above the large tire of the wheelchair.

12. The apparatus of claim 11 wherein said restraint includes a clip fastened to an inside surface of said body near said rear portion, said clip having a pair of opposed tabs that are resilient.

13. The apparatus of claim 11 wherein said restraint includes a pair of thumbscrews with a threaded portion protruding into a space defined by said body;
each one of said threaded portions having a distal tip; and said pair of distal tips defining said throat.

14. The apparatus of claim 11 wherein said restraint includes a roller inside said rear portion of said fender, said roller configured to engage said large tire, and said restraint further including an elastic cord with a first end fixed to a sidewall of said fender and a second end configured to releasably engage said sidewall of said fender, said cord having a length sufficient to wrap around an axle of said chair so as to bias said rear portion of said fender toward said axle.

15. An apparatus for transporting persons while preventing contamination, said apparatus comprising:
a wheelchair having a pair of large wheels, each one of said large wheels having a brake configured to be manually operated by an occupant of said wheelchair, said wheelchair having a seat positioned between said large wheels wherein the occupant in said seat propels said wheelchair by grasping and rotating a wheel member; and
a pair of fenders, each one of said fenders including a body, a front attachment, and a rear attachment,
each one of said bodies extending over a top of an associated one of said pair of large wheels,
each one of said front attachments connected to a corresponding first member of said wheelchair,
each one of said rear members connected to a corresponding second member of said wheelchair,
wherein each one of said bodies is supported in a spaced apart relationship to said associated one of said pair of large wheels.

16. The apparatus of claim 15 wherein each one of said bodies includes an outboard sidewall that extends toward an axle of an associated one of said large wheels, and said outboard sidewall extends radially inward past a handrim on said associated one of said large wheels wherein said outboard sidewall is disposed between said associated one of said large wheels and said handrim.

17. The apparatus of claim 15 wherein each one of said front attachments includes a clamp configured to attach to an associated one of said brake of said wheelchair.

18. The apparatus of claim 15 wherein each one of said rear attachments includes an elastic strap configured to engage an associated axle portion of said large tire.

19. The apparatus of claim 15 wherein each one of said rear attachments includes a member that engages an associated rim of said large tire on said wheelchair.

20. The apparatus of claim 15 wherein each one of said rear attachments is flexible such that a force applied to said body in a direction toward an axle of said large tire causes said body to engage a surface of said large tire whereby said body acts as a manual brake for said wheelchair.
